(19) United States
(12) Patent Application Publication
(10) Pub. No.: US 2025/0253898 A1
(43) Pub. Date: Aug. 7, 2025

(54) INTELLIGENT REFLECTING SURFACE

(71) Applicant: Japan Display Inc., Tokyo (JP)

(72) Inventors: Masayuki IKARI, Tokyo (JP); Takanori TSUNASHIMA, Tokyo (JP); Hiromi MATSUNO, Fujimino-shi (JP); Takuya OHTO, Fujimino-shi (JP); Yoshiaki AMANO, Fujimino-shi (JP)

(73) Assignee: Japan Display Inc., Tokyo (JP)

(21) Appl. No.: 19/189,319

(22) Filed: Apr. 25, 2025

Related U.S. Application Data
(63) Continuation of application No. PCT/JP2023/034537, filed on Sep. 22, 2023.

(30) Foreign Application Priority Data
Nov. 29, 2022 (JP) 2022-190517

(51) Int. Cl. H04B 7/04; H01Q 15/14; H01Q 21/06

(52) U.S. Cl. CPC H04B 7/04013; H01Q 15/14; H01Q 21/065

(57) ABSTRACT

An intelligent reflecting surface in one embodiment includes a plurality of patch electrodes, a common electrode opposite the plurality of patch electrodes, and a liquid crystal layer between the plurality of patch electrodes and the common electrode. The plurality of patch electrodes includes a first patch electrode, a second patch electrode adjacent to the first patch electrode, and a third patch electrode adjacent to the second patch electrode. An area of the first patch electrode is larger than an area of the second patch electrode. The area of the second patch electrode is larger than an area of the third patch electrode.

### CROSS-REFERENCE TO RELATED APPLICATIONS

This application is a Continuation of International Patent Application No. PCT/JP2023/034537, filed on Sep. 22, 2023, which claims the benefit of priority to Japanese Patent Application No. 2022-190517, filed on Nov. 29, 2022, the entire contents of each are incorporated herein by reference.

### FIELD

An embodiment of the present invention relates to an intelligent reflecting surface (radio-wave reflecting device).

### BACKGROUND

Conventional radio-wave reflective devices that utilize changes in a dielectric constant due to an orientation state of liquid crystals are known (for example, Japanese laid-open patent publication No. 2019-530387). The conventional radio-wave reflective device includes a plurality of reflective cells arranged on a plane, and each reflective cell includes a liquid crystal cell in which a liquid crystal is arranged between a pair of electrodes. The conventional radio-wave reflective device can adjust a direction of travel of radio waves reflected by each reflective cell by controlling an orientation state of the liquid crystal by controlling a voltage applied to each reflective cell.

### SUMMARY

An intelligent reflecting surface in one embodiment of the present invention includes a plurality of patch electrodes, a common electrode opposite the plurality of patch electrodes, and a liquid crystal layer between the plurality of patch electrodes and the common electrode. The plurality of patch electrodes includes a first patch electrode, a second patch electrode adjacent to the first patch electrode, and a third patch electrode adjacent to the second patch electrode. An area of the first patch electrode is larger than an area of the second patch electrode. The area of the second patch electrode is larger than an area of the third patch electrode.

An intelligent reflecting surface in one embodiment of the present invention includes a plurality of patch electrodes, a common electrode opposite the plurality of patch electrodes, and a liquid crystal layer between the plurality of patch electrodes and the common electrode. The plurality of patch electrodes includes a first patch electrode, a second patch electrode adjacent to the first patch electrode, and a third patch electrode adjacent to the second patch electrode. A first phase difference between a reflected wave by a first reflector unit cell containing the first patch electrode and a reflected wave by a second reflector unit cell containing the second patch electrode is the same as a second phase difference between the reflected wave by the second reflector unit cell and a reflected wave by a third reflector unit cell containing the third patch electrode.

### BRIEF DESCRIPTION OF THE DRAWINGS

FIG. 1 is a plan view showing a configuration of a radio-wave reflective device of one embodiment of the present invention.

FIG. 2A is a plan view showing a configuration of a reflector unit cell in a radio-wave reflective device of one embodiment of the present invention.

FIG. 2B is a cross-sectional view showing a configuration of a reflector unit cell in a radio-wave reflective device of one embodiment of the present invention.

FIG. 3A is a diagram showing an operating state of a reflector unit cell in a radio-wave reflective device of one embodiment of the present invention.

FIG. 3B is a diagram showing an operating state of a reflector unit cell in a radio-wave reflective device of one embodiment of the present invention.

FIG. 4 is a schematic diagram explaining a direction of travel of a reflected wave in a controlled state in a radio-wave reflective device of one embodiment of the present invention.

FIG. 5 is a schematic diagram explaining a direction of travel of a reflected wave in a no-electric-field state in a radio-wave reflective device of one embodiment of the present invention.

FIG. 6 is a plan view showing a configuration of a radio-wave reflective device in a modification of one embodiment of the present invention.

FIG. 7 is a plan view showing a configuration of a radio-wave reflective device of another embodiment of the present invention.

FIG. 8 is a cross-sectional view showing a configuration of a reflector unit cell in a radio-wave reflective device of another embodiment of the present invention.

FIG. 9 is a plan view showing a configuration of a radio-wave reflective device in a modification of another embodiment of the present invention.

### DESCRIPTION OF EMBODIMENTS

The radio-wave reflective device described above has a limit to a controllable range (a range in which a direction of travel of a radio wave can be adjusted) even if an orientation state of a liquid crystal is changed to the maximum extent, and it is not capable of responding to all directions. Therefore, if it is desired to supply radio waves to an area outside the controllable range of the radio-wave reflective device, it was necessary to adjust a direction of a reflective surface (action surface) of the radio-wave reflective device in advance and set it so that the area falls within the controllable range of the radio-wave reflective device. However, depending on the environment in which the radio-wave reflective device is installed, it was sometimes difficult to orient a reflective surface of the radio-wave reflective device in the desired direction.

An object of one embodiment of the present invention is to provide a radio-wave reflective device that has directionality in its initial state.

Hereinafter, an embodiment of the present invention will be described with reference to the drawings, and the like. However, the invention can be implemented in many different ways and is not to be interpreted as limited to the description of the embodiments shown below. Although the drawings may be schematically represented in terms of width, thickness, shape, and the like of each part compared to the actual embodiment in order to make the description clearer, this is only an example and does not limit the interpretation of the invention.

In this specification and in each figure, elements similar to those described above with respect to the figures already mentioned may be marked with the same reference sign and detailed explanations may be omitted as appropriate. For convenience of explanation, elements having a common function may be distinguished by adding the letters “a”, “b”, or the like after the same sign. However, in the case where there is no particular need to distinguish between them, they may be explained with the same reference sign. Furthermore, the terms “first” and “second” attached to each element are merely labels used for convenience to distinguish each element, and have no other meaning unless otherwise specified.

In the case where this specification refers to one component or area being “above (or below)” another component or area, unless otherwise specified, this includes not only the case where it is directly above (or below) the other component or area, but also the case where it is above (or below) the other component or area, that is, this includes the case where another component is included in between above (or below) the other component or area.

In this specification, unless otherwise specified, expressions such as “a includes A, B, or C” “a includes any of A, B or C”, “a includes one selected from a group consisting of A, B and C” does not exclude the case where a includes a combination of multiple A to C, unless otherwise specified. Furthermore, these expressions do not exclude the case where a includes other elements.

### First Embodiment

### [Configuration of Radio-Wave Reflective Device]

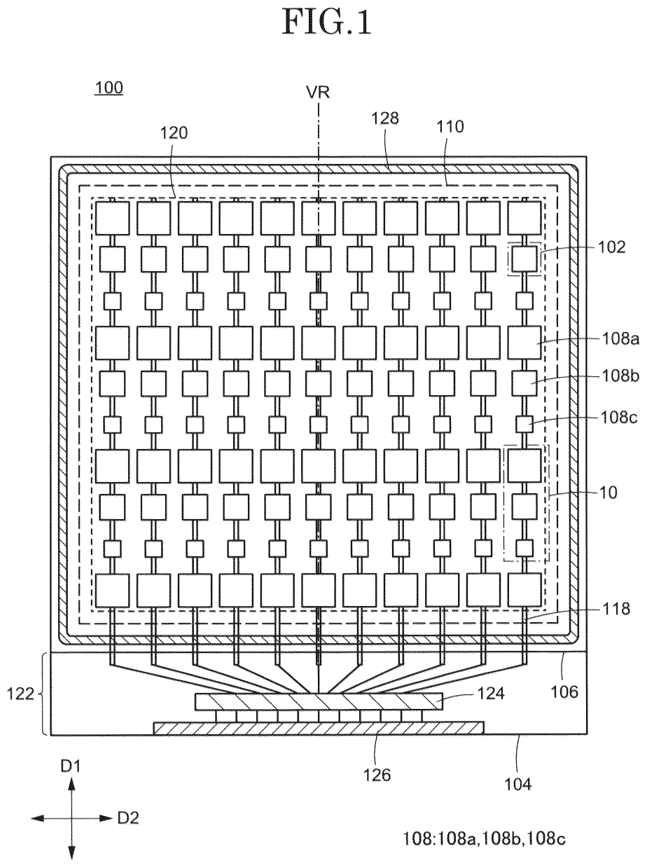

FIG. 1 is a plan view showing a configuration of a radio-wave reflective device 100 of an embodiment of the present invention. The radio-wave reflective device 100 of this embodiment has a configuration in which an electrode group consisting of a plurality of patch electrodes 108 connected in series in a first direction (direction D1) is arranged in a row in a second direction (direction D2) that intersects the first direction. In FIG. 1, the first direction (up and down direction when facing the drawing) corresponds to a column direction, and the second direction (left and right direction when facing the drawing) corresponds to a row direction. In this embodiment, an example will be described in which one-dimensional control is performed by using the plurality of patch electrodes 108 connected in the first direction to change a direction of travel of a reflected wave in the second direction with a reflection axis VR as a rotation axis.

As shown in FIG. 1, the radio-wave reflective device 100 has a reflector 120. The reflector 120 is composed of a plurality of reflector unit cells 102. The plurality of reflector unit cells 102 in this embodiment are arranged in a matrix in the first (column) and second (row) directions described above. The specific structure of the reflector unit cell 102 is described below. The reflector unit cells 102 are arranged so that the plurality of patch electrodes 108 faces a plane of incidence of radio waves. The reflector 120 is a flat plate-shaped structure composed of the plurality of reflector unit cells 102, and a direction of travel of the radio waves (reflected waves) reflected by the reflector 120 is controlled by a size (area) of each patch electrode 108 and a voltage applied to each patch electrode 108.

As shown in FIG. 1, the plurality of patch electrodes 108 in the radio-wave reflective device 100 includes a patch electrode 108a, a patch electrode 108b adjacent to the patch electrode 108a, and a patch electrode 108c adjacent to the patch electrode 108b. An area of the patch electrode 108a is larger than an area of the patch electrode 108b. However, this example is not limited to this example, and a relationship between sizes of areas may be reversed. That is, among the patch electrodes 108a to 108c, the patch electrode 108c may have the largest area and the patch electrode 108a may have the smallest area.

Thus, in this configuration, the plurality of patch electrodes 108a to 108c, which differ in area from each other, is periodically arranged in the row in the first direction. The reason for this configuration is described below. The plurality of patch electrodes 108a to 108c is connected to each other by a first wiring 118. As shown in FIG. 1, the first wiring 118 extends in the first direction and is arranged in a plurality of locations along the second direction. Therefore, in this embodiment, patch electrodes 108 of the same area are lined up in the second direction. For example, a patch electrode 108a is adjacent to a patch electrode 108b with a different area in the first direction and adjacent to another patch electrode 108a (a patch electrode 108a connected to another first wiring 118) in the second direction.

The radio-wave reflective device 100 has a structure in which a plurality of reflector unit cells 102 are integrated on a single dielectric substrate (dielectric layer) 104. As shown in FIG. 1, the radio-wave reflective device 100 has a structure in which the dielectric substrate 104 on which the plurality of patch electrodes 108 are arranged, and an opposing substrate 106 on which a common electrode 110 opposing the plurality of patch electrodes 108 is provided, are arranged in an overlapping configuration, and a liquid crystal layer (not shown) is provided between the two substrates.

The reflector 120 is formed in the area where the plurality of patch electrodes 108 and the common electrode 110 overlap. The dielectric substrate 104 and the opposing substrate 106 are bonded together using a seal material 128, which is composed of, for example, a light-curing resin material. Although not shown in the figure, the liquid crystal layer is provided in the area inside the seal material 128.

In addition to the area facing the opposing substrate 106, the dielectric substrate 104 has a peripheral region 122 that extends outward from the opposing substrate 106. The peripheral region 122 is provided with a first drive circuit 124 and a terminal portion 126. The first drive circuit 124 outputs control signals to each patch electrode 108. The terminal portion 126 is a region that functions as a connection to an external circuit (not shown) and is connected to, for example, a flexible printed circuit board, which is not shown in the figure. Signals for controlling the first drive circuit 124 are input to the terminal portion 126.

In the reflector 120, the plurality of patch electrodes 108 are connected to the first wiring 118 extending in the first direction. In other words, each patch electrode 108 is interconnected via the first wiring 118. The reflector 120 has a configuration in which a plurality of electrode groups comprising the plurality of patch electrodes 108 connected in the first direction (column direction) by the first wiring 118 are arranged in the second direction (row direction).

The plurality of first wirings 118 extend to the peripheral region 122 and are connected to the first drive circuit 124. The first drive circuit 124 outputs control signals to be supplied to each patch electrode 108. Specifically, the first drive circuit 124 can output control signals of different voltages to each of the plurality of first wirings 118. By supplying different control signals to each of the first wirings 118 (that is, applying different voltages to each first wiring 118), in the reflector 120, different control signals are supplied to each column of the multiple patch electrodes 108 arranged in the first and second directions (that is, for each electrode group composed of the plurality of patch electrodes 108 arranged in the first direction).

The radio-wave reflective device 100 can control the direction of travel of a reflected wave of the radio waves incident on the reflector 120 by supplying a different control signal to each electrode group consisting of the plurality of patch electrodes 108 arranged in the first direction. In other words, the radio-wave reflective device 100 can change the reflection direction of the radio wave irradiated on the reflector 120 in the left and right directions (row direction) of the drawing centering on the reflection axis VR parallel to the first direction.

### [Reflector Unit Cell Configuration]

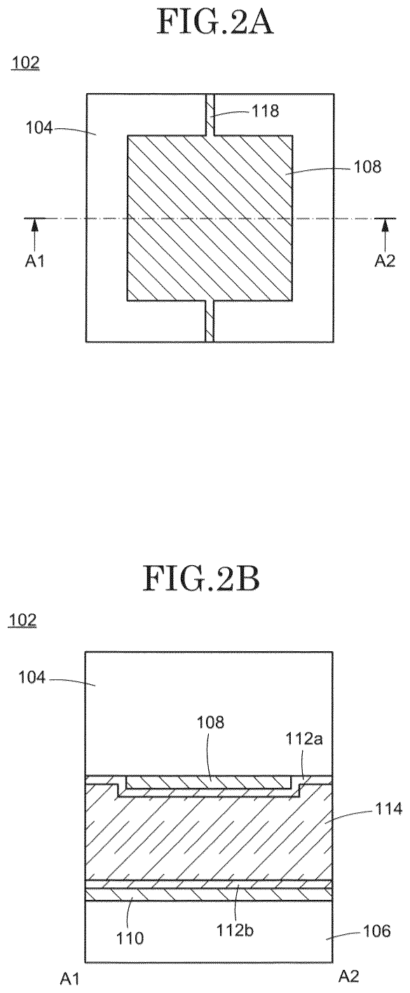

FIG. 2A is a plan view showing the configuration of the reflector unit cell 102 in the radio-wave reflective device 100 of one embodiment of the invention. FIG. 2B is a cross-sectional view showing a configuration of the reflector unit cell 102 in the radio-wave reflective device 100 of one embodiment of the present invention. Specifically, FIG. 2B corresponds to a cross-sectional view of the reflector unit cell 102 shown in FIG. 2A taken along a line A1-A2.

As shown in FIG. 2A and FIG. 2B, the reflector unit cell 102 includes the dielectric substrate 104, the counter substrate 106, the patch electrode 108, the common electrode 110, a liquid crystal layer 114, a first alignment film 112a, and a second alignment film 112b. In addition, in FIG. 2A and FIG. 2B, although the description will be given by referring to the patch electrode 108, unless otherwise specified, the description of the patch electrode 108 is common to the patch electrode 108a, the patch electrode 108b, and the patch electrode 108c.

The patch electrode 108 is provided on the dielectric substrate 104. In the reflector unit cell 102, the dielectric substrate 104 can be regarded as a dielectric layer having a predetermined dielectric constant. The common electrode 110 is provided on the opposing substrate 106. The first alignment film 112a is provided to cover the patch electrode 108. The second alignment film 112b is provided to cover the common electrode 110. The patch electrode 108 and the common electrode 110 are arranged to face each other with the liquid crystal layer 114 interposed therebetween. The first alignment film 112a is interposed between the patch electrode 108 and the liquid crystal layer 114, and the second alignment film 112b is interposed between the common electrode 110 and the liquid crystal layer 114.

It is preferable that the patch electrode 108 has a shape that is symmetrical in a plan view. However, this may not be the case depending on the structure of the patch electrodes, such as their interconnections. FIG. 2A shows an example where the patch electrode 108 is square in a plan view. There is no particular limitation on the shape of the common electrode 110. The common electrode 110 in this embodiment is provided over substantially the entire surface of the opposing substrate 106 so as to face the plurality of patch electrodes 108. There is no limitation on the material comprising each patch electrode 108 and common electrode 110, and they are composed of a conductive metallic material or metal oxide material or the like.

As shown in FIG. 1, the dielectric substrate 104 has a first wiring 118 that is connected to the patch electrode 108. In this embodiment, although the first wiring 118 is integrally formed with the patch electrode 108, it is not limited to this example. That is, the first wiring 118 and the patch electrode 108 may be formed as separate elements and electrically connected to each other. The first wiring 118 is used to supply control signals to the patch electrode 108. Although only one patch electrode 108 is shown in FIG. 2A, the patch electrode 108 is connected to other adjacent patch electrodes 108 via the first wiring 118 as shown in FIG. 1.

Although not shown in FIG. 2A and FIG. 2B, the dielectric substrate 104 and the opposing substrate 106 are attached to each other by the seal material 128, as shown in FIG. 1. The dielectric substrate 104 and the opposing substrate 106 are arranged facing each other with a gap, and the liquid crystal layer 114 is arranged within a region surrounded by the seal material 128. In other words, the liquid crystal layer 114 is arranged to fill the gap between the dielectric substrate 104 and the opposing substrate 106.

Since the patch electrode 108, the common electrode 110, the first alignment film 112a, and the second alignment film 112b are arranged between the dielectric substrate 104 and the opposing substrate 106, a distance between the first alignment film 112a and the second alignment film 112b on each of the dielectric substrate 104 and the opposing substrate 106 is precisely a thickness of the liquid crystal layer 114. In addition, although not shown in FIG. 2B, a spacer may be provided between the dielectric substrate 104 and the opposing substrate 106 to keep the spacing constant.

As mentioned above, a control signal is supplied to the patch electrode 108 to control orientation of liquid crystal molecules in the liquid crystal layer 114. The control signal is a DC voltage signal or a polarity reversal signal that alternately reverses between positive and negative DC voltages. A ground voltage or a middle level voltage of a polarity inversion signal is applied to the common electrode 110.

When a control signal is supplied to the patch electrode 108, an orientation state of the liquid crystal molecules in the liquid crystal layer 114 changes. As the liquid crystal layer 114, a liquid crystal material having an anisotropic dielectric constant is used. For example, nematic, smectic, cholesteric, or discotic liquid crystals can be used as the liquid crystal layer 114. The liquid crystal layer 114 has dielectric anisotropy, and the dielectric constant changes with the change in the orientation state of the liquid crystal molecules. The reflector unit cell 102 can delay a phase of reflected waves when reflecting radio waves by changing the dielectric constant of the liquid crystal layer 114 using a control signal supplied to the patch electrode 108 (that is, a voltage applied to the patch electrode 108).

Frequency bands of the radio waves reflected by the reflector unit cell 102 are a very high frequency (VHF) band, an ultra-high frequency (UHF) band, a super high frequency (SHF) band, a submillimeter wave (THF: Tremendously high frequency) band, and a millimeter wave (EHF: Extra High Frequency) band. Although the orientation of the liquid crystal molecules in the liquid crystal layer 114 changes in response to the control signal supplied to the patch electrode 108, it hardly follows the frequency of the radio waves irradiated to the patch electrode 108. Therefore, the reflector unit cell 102 can control the phase of the reflected radio waves without being affected by the radio waves.

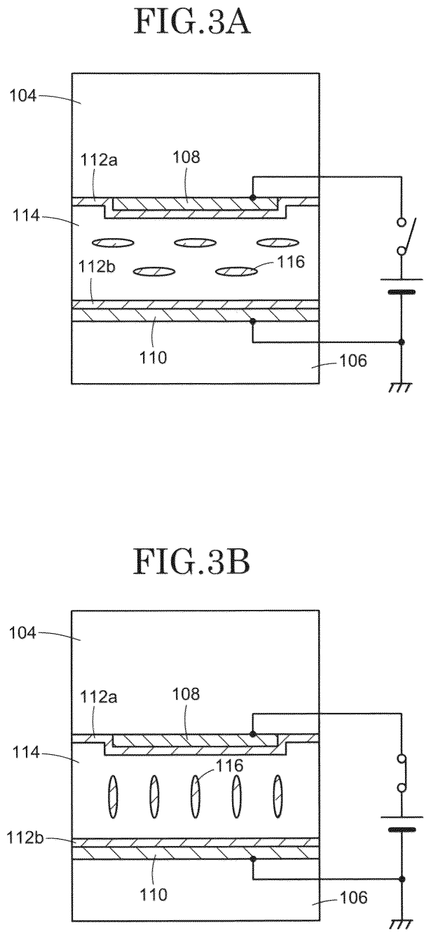

FIG. 3A and FIG. 3B are diagrams showing operating states of the reflector unit cell 102 in the radio-wave reflective device 100 of one embodiment of the invention. Specifically, FIG. 3A shows a state in which no control signal is supplied to the patch electrode 108, that is, the patch electrode 108 and the common electrode 110 are equipotential (hereinafter referred to as a “no electric field state”). FIG. 3B shows a state in which a control signal is supplied to the patch electrode 108, that is, a potential difference is generated between the patch electrode 108 and the common electrode 110 (hereinafter referred to as an “electric field formation state”). However, in FIG. 3A, the first alignment film 112a and the second alignment film 112b are both horizontally oriented films.

As shown in FIG. 3A, the long axes of the liquid crystal molecules 116 in the no electric field state are oriented substantially horizontally to surfaces of the patch electrode 108 and the common electrode 110 by the first alignment film 112a and the second alignment film 112b. In contrast, in the electric field formation state, the long axes of the liquid crystal molecules 116 are oriented substantially perpendicular to the surfaces of the patch electrode 108 and the common electrode 110 under action of the formed electric field. An angle at which the long axes of the liquid crystal molecules 116 are oriented varies depending on the magnitude of the potential difference (voltage) between the patch electrode 108 and the common electrode 110. Therefore, by controlling the potential difference between the patch electrode 108 and the common electrode 110, it is possible to orient them in a direction intermediate between the horizontal and vertical directions.

The reflector unit cell 102 can be controlled to delay (or not) the phase of the reflected wave by using the dielectric constant anisotropy of the liquid crystal layer 114. The liquid crystal layer 114 with dielectric constant anisotropy can be regarded as a variable dielectric layer. The liquid crystal molecules 116 have a positive or negative dielectric anisotropy depending on the material. Therefore, when controlling the phase change, the initial orientation state and the magnitude and polarity of the electric field applied to the liquid crystal layer 114 may be appropriately selected depending on whether the dielectric anisotropy is positive or negative.

### [Basic Operation of Radio-Wave Reflective Device]

The basic operation of the radio-wave reflective device 100 is described next. As described above, the reflector unit cell 102 can advance or delay the phase of the reflected wave (radio wave to be reflected) depending on the voltage applied to the patch electrode 108. Using this principle, the radio-wave reflective device 100 can control the direction of travel of the reflected wave.

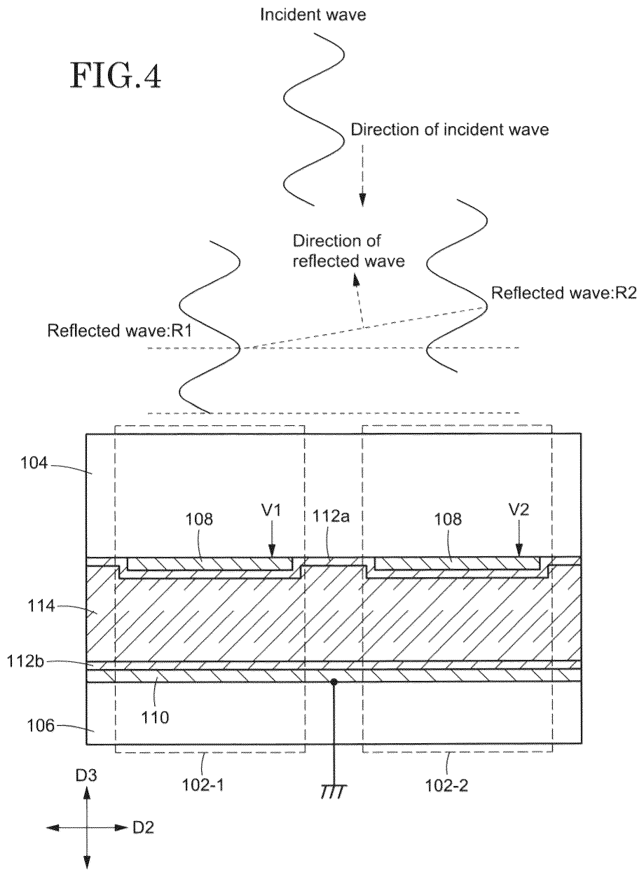

FIG. 4 is a schematic diagram showing a direction of travel of the reflected wave in a controlled state in one embodiment of the radio-wave reflective device 100. Specifically, FIG. 4 is a schematic diagram showing how the direction of travel of the reflected wave is changed by two reflector unit cells 102-1 and 102-2. As shown in FIG. 4, radio waves (incident waves) of the same phase are incident on each of the reflector unit cells 102-1 and 102-2. In addition, in FIG. 4, a third direction (direction D3) is orthogonal to the first direction (direction D1) and the second direction (direction D2) (a direction perpendicular to the reflecting surface of the reflector 120).

In FIG. 4, areas of the patch electrodes 108 of the reflector unit cells 102-1 and 102-2 shall be equal. For example, the patch electrodes 108 in each of the reflector unit cells 102-1 and 102-2 may be the patch electrodes 108a shown in FIG. 1. In this case, radio waves (reflected waves) of the same phase are emitted from each of the reflector unit cells 102-1 and 102-2 in the no electric field state in which no voltage is applied to the liquid crystal layer 114. In other words, the reflected waves from reflector unit cells 102-1 and 102-2 travel in a direction parallel to the incident direction of the incident wave.

On the other hand, in the case where different voltages are applied to reflector unit cell 102-1 and reflector unit cell 102-2 (V1≠V2), a dielectric constant of the liquid crystal layer 114 in the reflector unit cell 102-1 and a dielectric constant of the liquid crystal layer 114 in the reflector unit cell 102-2 are different from each other. As a result, as shown in FIG. 4, a phase of a reflected wave R1 reflected in the reflector unit cell 102-1 and a phase of a reflected wave R2 reflected in the reflector unit cell 102-2 differ, and the direction of travel of the reflected wave apparently changes in an oblique direction. Specifically, in FIG. 4, the phase of the reflected wave R2 is more advanced than that of the reflected wave R1, so the reflected wave travels obliquely toward the left (second direction).

In this manner, the radio-wave reflective device 100 of this embodiment can make the phases of the reflected waves in the reflector unit cells including the respective patch electrodes 108 different by applying different voltages to the adjacent patch electrodes 108. In this embodiment, as shown in FIG. 1, the plurality of patch electrodes 108 aligned in the first direction (column direction) are connected to each other by the first wiring 118 and are equipotential. In other words, in this embodiment, the voltage applied to the patch electrodes 108 can be different for each electrode group consisting of a plurality of patch electrodes 108 lined up in the first direction. In other words, the voltage applied to one first wiring 118 and the voltage applied to another first wiring 118 (another first wiring 118 adjacent in the second direction) can be different from each other.

As explained above, the radio-wave reflective device 100 of this embodiment can apply different voltages to each group of electrodes consisting of the plurality of patch electrodes 108 connected to each first wiring 118 by supplying different control signals to each of the plurality of first wirings 118 in FIG. 1. As a result, the radio wave reflected by the reflector 120 travels toward a direction having a predetermined angle with respect to the incident direction of the incident wave in accordance with the voltage applied to each first wiring 118. Specifically, the radio-wave reflective device 100 can change the direction of travel of the reflected wave in the second direction (row direction) with the reflection axis VR (see FIG. 1) as the rotation axis.

### [Initial Phase Control of Radio-Wave Reflective Device]

As described above, the radio-wave reflective device 100 of this embodiment can control the direction of travel of the reflected wave by controlling the voltage applied to the liquid crystal layer 114 in each reflector unit cell 102. In addition to such control by voltage, the radio-wave reflective device 100 of this embodiment can set the direction of travel of the reflected wave to a predetermined direction even in the initial state (for example, in the no electric field state where no voltage is applied to the liquid crystal layer 114). Specifically, in this embodiment, as shown in FIG. 1, the plurality of patch electrodes 108 arranged in the first direction (column direction) includes patch electrodes 108a to 108c each having a different area from one another. With this configuration, the radio-wave reflective device 100 can change the direction of travel of the reflected wave relative to the incident wave toward the first direction (column direction).

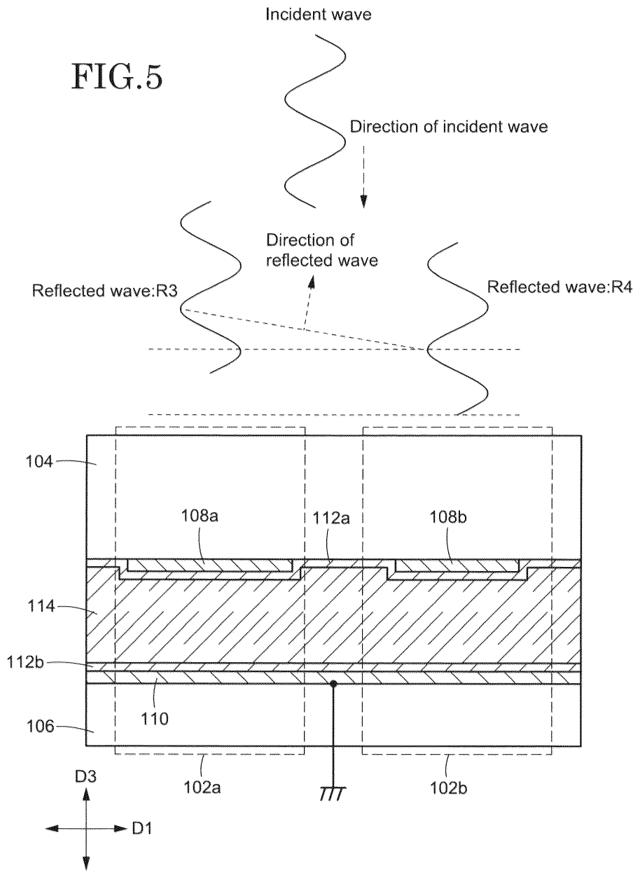

FIG. 5 is a schematic diagram showing the direction of travel of reflected waves in a no-electric-field state in the radio-wave reflective device 100 of one embodiment of the present invention. Specifically, FIG. 5 schematically shows how the direction of travel of the reflected wave is changed by the two reflector unit cells 102a and 102b. Here, reflector unit cells 102a and 102b respectively include patch electrodes 108a and 108b shown in FIG. 1. Radio waves (incident waves) of the same phase are incident on each of the reflector unit cells 102a and 102b.

As shown in FIG. 5, the patch electrode 108a in the reflector unit cell 102a and the patch electrode 108b in the reflector unit cell 102b have different areas from each other. In this embodiment, the area of the patch electrode 108a is larger than that of the patch electrode 108b. Here, the area of the patch electrode 108 affects a value of the capacitance (capacitance with the liquid crystal layer 114 as the dielectric) composed of the patch electrode 108, the liquid crystal layer 114, and the common electrode 110. In other words, since the area of the patch electrode 108a and the area of the patch electrode 108b differ from each other, the capacitance value in the reflector unit cell 102a is different from the capacitance value in the reflector unit cell 102b. The value of the capacitance in the reflector unit cell 102 affects the phase of the radio wave reflected by the reflector unit cell 102.

As a result, as shown in FIG. 5, a difference occurs between the phase of a reflected wave R3 reflected in the reflector unit cell 102a and the phase of a reflected wave R4 reflected in the reflector unit cell 102b, and the direction of travel of the reflected wave apparently changes obliquely. Specifically, in FIG. 5, the phase of the reflected wave R4 is delayed compared to that of the reflected wave R3, so the reflected wave travels obliquely toward the right direction (first direction). Although the figure is omitted, such a relationship also applies to the patch electrode 108b and the patch electrode 108c.

In this embodiment, a phase of a reflected wave reflected by a reflector unit cell (not shown; hereinafter, referred to as “reflector unit cell 102c”.) including the patch electrode 108c lags behind the phase of the reflected wave R4 reflected by the reflector unit cell 102b. At this time, a phase difference between the wave reflected by the reflector unit cell 102a and the wave reflected by the reflector unit cell 102b shown in FIG. 5 is the same as a phase difference between the wave reflected by the reflector unit cell 102b and the wave reflected by the reflector unit cell 102c. By making this relationship, the reflected wave in a reflector unit cell group 10 including each of the reflector unit cells 102a to 102c travels toward a direction having a predetermined angle with respect to the incident wave. In addition, in the above explanation, the phase differences being the same includes not only the case where the phase differences are completely the same, but also the case where the phase differences do not match within a range of ±5%. For example, if the phase of the reflected wave by the reflector unit cell 102a (first phase) is used as a reference, even if the phase of the reflected wave by the reflector unit cell 102b (second phase) differs from the first phase of ±5%, the first phase and the second phase are considered to be the same.

Thus, in the radio-wave reflective device 100 of this embodiment, by making the areas of the patch electrodes 108 adjacent to each other different, it is possible to make the phases of the reflected waves in the reflector unit cells 102a to 102c, each of which includes a patch electrode 108a to 108c, different even in a state in which no electric field is applied to the liquid crystal layer 114 (electric field-free state). Therefore, radio waves reflected in the reflector unit cell group 10, which is composed of reflector unit cells 102a to 102c, travel obliquely along the direction in which the reflector unit cells 102a to 102c are aligned. A plurality of such reflector unit cell groups 10 (see FIG. 1) are arranged in series in the first direction and a plurality of such reflector unit cell groups 10 are arranged side by side in the second direction to form a reflector 120. As a result, the radio-wave reflective device 100 can change the direction of travel of the reflected wave relative to the incident wave toward the first direction (column direction).

As explained above, in the initial state (for example, no electric field state in which no voltage is applied to the liquid crystal layer 114), the radio-wave reflective device 100 of this embodiment is set so that the direction of travel of the reflected wave relative to the incident wave is tilted in the first direction (column direction) in advance. In other words, in a state before voltage control is applied to the radio-wave reflective device 100, the reflected wave can be reflected toward a predetermined direction (in this embodiment, along the first direction) in advance. Furthermore, the radio-wave reflective device 100 can change the traveling direction of the reflected wave to the second direction by controlling the voltage, with the reflection axis VR serving as the rotation axis.

In this embodiment, although the no electric-field state, in which no voltage is applied to the liquid crystal layer 114, is shown as an example of an initial state, the present embodiment is not limited to this. For example, even in a state where the same voltage is applied to all 108 patch electrodes (equipotential state), the reflected wave from each reflector unit cell shows the same reflection pattern as the no electric field state because no phase difference is generated. Therefore, in this specification, the initial state includes the equipotential state described above in addition to the no electric field state.

### [Modification 1 of First Embodiment]

Although FIG. 1 shows an example in which the plurality of reflector unit cell groups 10 including three patch electrodes 108a to 108c are arranged in series in the first direction, this example is not limited to this. For example, the number of patch electrodes 108 included in the reflector unit cell group 10 may be two, or may be four or more.

In the case where four or more patch electrodes 108 are included in the reflector unit cell group 10, a relationship of an area of each patch electrode 108 is the same as in FIG. 1. That is, each patch electrode 108 included in the reflector unit cell group 10 has a relationship where the patch electrode located at one end has the largest area and the patch electrode located at the other end has the smallest area. However, even in this case, it is preferable that the phase difference between two adjacent reflector unit cells is the same between each reflector unit as described above.

### [Modification 2 of First Embodiment]

In FIG. 1, although an example in which the areas of adjacent patch electrodes 108 in the first direction are made different has been described, this is not limited to this example, and it is also possible to make the areas of adjacent patch electrodes 108 in the second direction different.

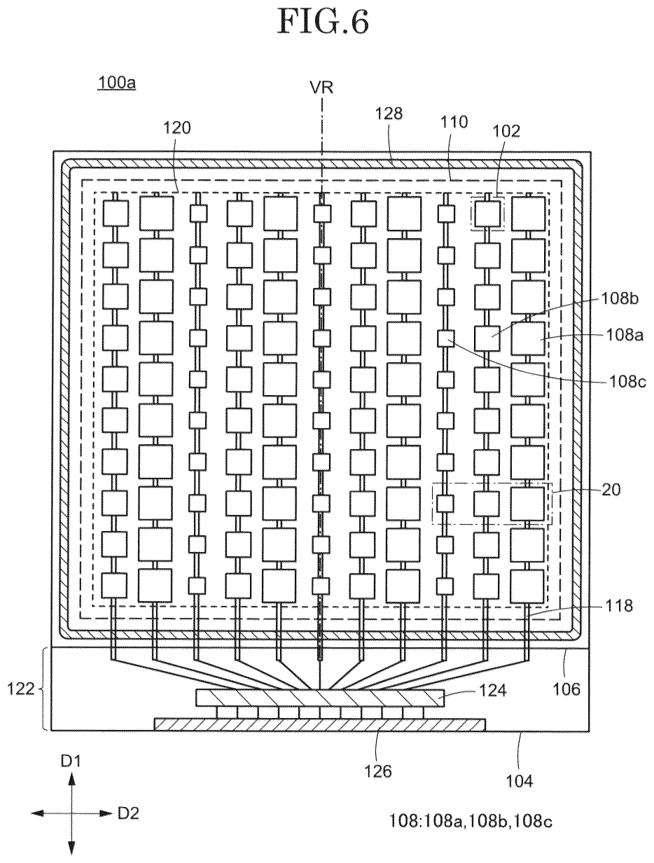

FIG. 6 is a plan view of the configuration of a radio-wave reflective device 100a in a modification of one embodiment of the present invention. The radio-wave reflective device 100a of this embodiment has a configuration in which a plurality of electrode groups 20 comprising the plurality of patch electrodes 108 aligned in the second direction (direction D2) are arranged side by side in the first direction (direction D1). In an initial state, the radio-wave reflection device 100a of this embodiment is set so that a direction of travel of a reflected wave relative to an incident wave is inclined in the second direction (row direction) in advance. In other words, in a state before voltage control is applied to the radio-wave reflective device 100a, the reflected wave can be reflected toward the predetermined direction (in FIG. 6, along the second direction) in advance.

Furthermore, the radio-wave reflective device 100a can change the direction of travel of the reflected wave to the second direction by controlling the voltage, with the reflection axis VR serving as the rotation axis. In the initial state, the reflected wave is preset to head in the second direction, so in the case where voltage control is performed, the direction of travel of the reflected wave can be further changed from the preset direction as a reference direction to the second direction. By performing such control, the radio-wave reflective device 100a can send radio waves to locations where radio waves cannot be sent by voltage control alone. Specifically, in the initial state, the direction of travel of the reflected wave by the radio-wave reflective device 100a is tilted toward the direction of the location, and the direction of the reflected wave is further changed by voltage control based on that direction, making it possible for the radio waves to reach the desired location.

### Second Embodiment

In the first embodiment, an example of one-dimensional control in which the direction of travel of the reflected wave is changed in the second direction with the reflection axis VR as the rotation axis was described. In this embodiment, an example of two-dimensional control in which the direction of travel of the reflected wave is also changed in the first direction with a reflection axis HR as the rotation axis is described. Elements having the same functions as those in the first embodiment are indicated with the same reference signs, and redundant explanations are omitted.

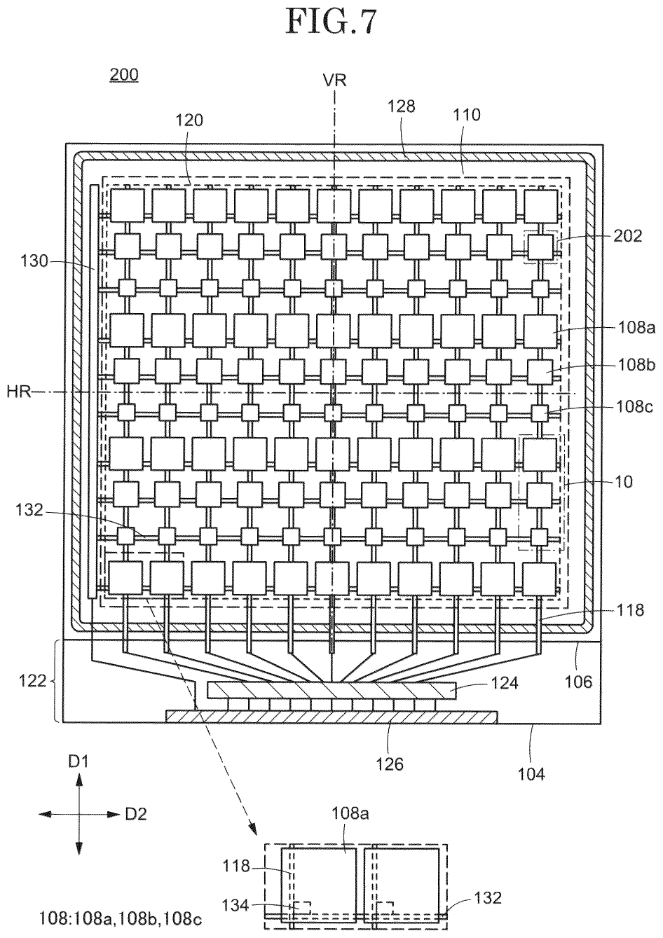

FIG. 7 is a plan view showing a radio-wave reflective device 200 of an embodiment of the present invention. The radio-wave reflective device 200 of this embodiment has a plurality of second wirings 132 that extend in the second direction (row direction) as well as in the first direction (column direction), in addition to the plurality of first wirings 118 that extend in the first direction (column direction) as well as in the second direction. The plurality of first wirings 118 and the plurality of second wirings 132 intersect with an insulating layer not shown therebetween. The plurality of first wirings 118 are connected to the first drive circuit 124 that outputs control signals. The plurality of second wirings 132 are connected to a second drive circuit 130 that outputs scanning signals.

As shown in the enlarged view in FIG. 7, each reflector unit cell 202 includes a switching element 134. In this embodiment, the switching element 134 is a transistor. However, the present embodiment is not limited to this example and the switching element 134 may be any element that functions as a switch. In addition, in the enlarged view, although the reflector unit cell 202 including the patch electrode 108a is shown as an example, the reflector unit cell 202 including the patch electrode 108b or 108c has the same configuration.

The switching element 134 is connected to the first wiring 118 and the second wiring 132. Specifically, the first wiring 118 is connected to a source of the transistor that is the switching element 134, and the second wiring 132 is connected to a gate. A switching function of the switching element 134 is controlled by the scanning signal supplied to the second wiring 132. When the switching element 134 is turned on, the patch electrode 108 and the first wiring 118 are electrically connected and the control signal is supplied to the patch electrode 108. According to this configuration, the plurality of patch electrodes 108 arranged in the second direction can be selected row by row, and control signals of different voltages can be supplied to each row.

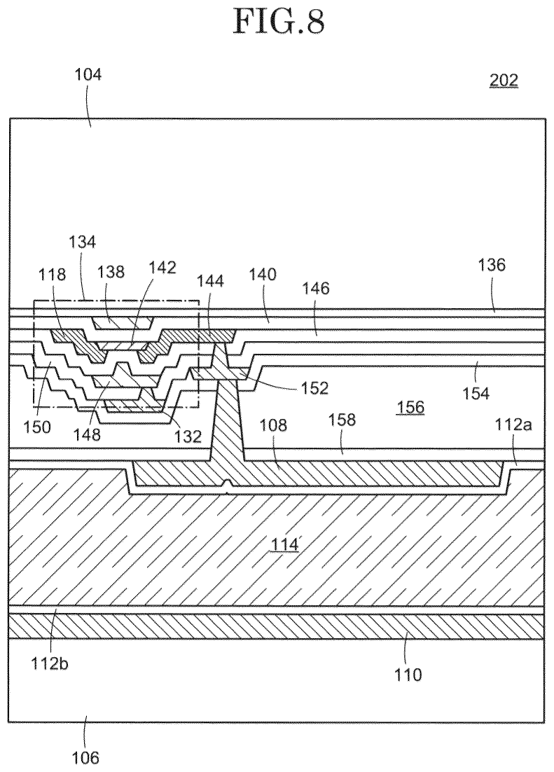

FIG. 8 is a cross-sectional view of the reflector unit cell 202 of the radio-wave reflective device 200 of another embodiment of the present invention. The switching element 134 includes a first gate electrode 138, a first gate insulation layer 140, a semiconductor layer 142, a second gate insulation layer 146, and a second gate electrode 148. An undercoat layer 136 is arranged between the first gate electrode 138 and the dielectric substrate 104.

The first wiring 118 and a first connection wiring 144 are arranged between the first gate insulating layer 140 and the second gate insulating layer 146. The first wiring 118 and the first connection wiring 144 are arranged in contact with the semiconductor layer 142. Specifically, the first wiring 118 is connected to a source side of the semiconductor layer 142, and the first connection wiring 144 is connected to a drain side of the semiconductor layer 142. However, the positional relationship of the source and drain may be reversed according to the voltage applied between the source and drain of the transistor.

The switching element 134 is covered by a first interlayer insulating layer 150. The second wiring 132 is arranged on the first interlayer insulating layer 150. The second wiring 132 is connected to the second gate electrode 148 through a contact hole formed in the first interlayer insulation layer 150. In addition, although not shown in the figure, the first gate electrode 138 and the second gate electrode 148 are electrically connected to each other in a region that does not overlap the semiconductor layer 142. On the first interlayer insulating layer 150, a second connection wiring 152 is arranged in the same conductive layer as the second wiring 132. The second connection wiring 152 is connected to the first connection wiring 144 through a contact hole formed in the second gate insulating layer 146 and the first interlayer insulating layer 150.

The second wiring 132 and the second connection wiring 152 are covered by a second interlayer insulating layer 154. On top of the second interlayer insulating layer 154, a planarization layer 156 is provided to fill steps formed by the switching element 134. By providing the planarization layer 156, the patch electrode 108 can be formed without being affected by undulations caused by the arrangement of the switching element 134. A passivation layer 158 is provided above the planarization layer 156. The patch electrode 108 is arranged over the passivation layer 158. The patch electrode 108 is connected to the second connection wiring 152 through a contact hole that penetrates the passivation layer 158, the planarization layer 156, and the second interlayer insulating layer 154. The first alignment film 112a is arranged over the patch electrode 108.

On the opposing substrate 106, the common electrode 110 and the second alignment film 112b are arranged as in FIG. 2B of the first embodiment. The surface on the opposing substrate 106 on which the common electrode 110 is provided is arranged to face a surface on which the patch electrode 108 is provided on the dielectric substrate 104. The liquid crystal layer 114 is arranged between the first alignment film 112a and the second alignment film 112b.

In the structure shown in FIG. 8, the undercoat layer 136 is formed of, for example, a silicon film. The first gate insulating layer 140 and the second gate insulating layer 146 are formed of, for example, a silicon oxide film or a stacked structure of a silicon oxide film and a silicon nitride film. Semiconductor layers are formed of, for example, silicon semiconductors such as amorphous silicon and polycrystalline silicon, and oxide semiconductors including metal oxides such as indium oxide, zinc oxide, and gallium oxide. The first gate electrode 138 and the second gate electrode 148 are formed of, for example, molybdenum (Mo), tungsten (W), or alloys thereof. The first wiring 118, the second wiring 132, the first connecting wiring 144, and the second connecting wiring 152 are formed using metal materials such as titanium (Ti), aluminum (Al), or molybdenum (Mo). For example, each wiring may be composed of a stacked structure of titanium (Ti)/aluminum (Al)/titanium (Ti) or a stacked structure of molybdenum (Mo)/aluminum (Al)/molybdenum (Mo). The planarization layer 156 is formed using a resin material such as acrylic, polyimide, or the like. The passivation layer 158 is formed using, for example, a silicon nitride film. The patch electrode 108 and the common electrode 110 are formed using a metal film such as aluminum (Al), copper (Cu), or a transparent conductive film such as indium tin oxide (ITO).

As shown in FIG. 8, the second wiring 132 is connected to the gate of the transistor used as the switching element 134, the first wiring 118 is connected to one of the source and drain of the transistor, and the patch electrode 108 is connected to the other of the source and drain. This allows the control signal to be supplied by selecting a predetermined patch electrode from the plurality of patch electrodes 108 arranged in a matrix.

Thus, the radio-wave reflective device 200 can control the voltage applied to the patch electrodes 108 for each reflector unit cell 202. Therefore, not only the applied voltage can be made different between patch electrodes 108 adjacent to each other in the second direction, but also the applied voltage can be made different between patch electrodes 108 adjacent to each other in the first direction. In other words, the radio-wave reflective device 200 of this embodiment has a function of controlling the direction of travel of the reflected wave in the first direction around the reflection axis HR in addition to a function of controlling the direction of travel of the reflected wave in the second direction around the reflection axis VR.

In addition, in the radio-wave reflective device 200 of this embodiment, by making areas of the patch electrodes 108 adjacent to each other in the first direction different, a phase of reflected waves in each reflector unit cell 202 including the respective patch electrodes 108a to 108c can be made different even in the initial state. In other words, similar to the radio-wave reflective device 100 of the first embodiment, the radio-wave reflective device 200 of this embodiment is set in the initial state so that the direction of travel of the reflected wave relative to the incident wave is inclined in the first direction (column direction) in advance. Therefore, in this embodiment, the direction of travel of the reflected wave inclined in the first direction in the initial state can be further changed to the first or second direction by voltage control.

For example, in the example shown in FIG. 7, since the reflected wave is preset to head in the first direction in the initial state, voltage control can further change the direction of travel of the reflected wave from the preset direction to the first direction. By performing such control, the radio-wave reflective device 200 can send radio waves to locations where radio waves cannot be sent by voltage control alone.

### [Modification 1 of Second Embodiment]

In FIG. 7, although an example in which the areas of the patch electrodes 108 adjacent to each other in the first direction are made different has been described, the present invention is not limited to this example, and it is also possible to make the areas of the patch electrodes 108 adjacent to each other in the second direction different.

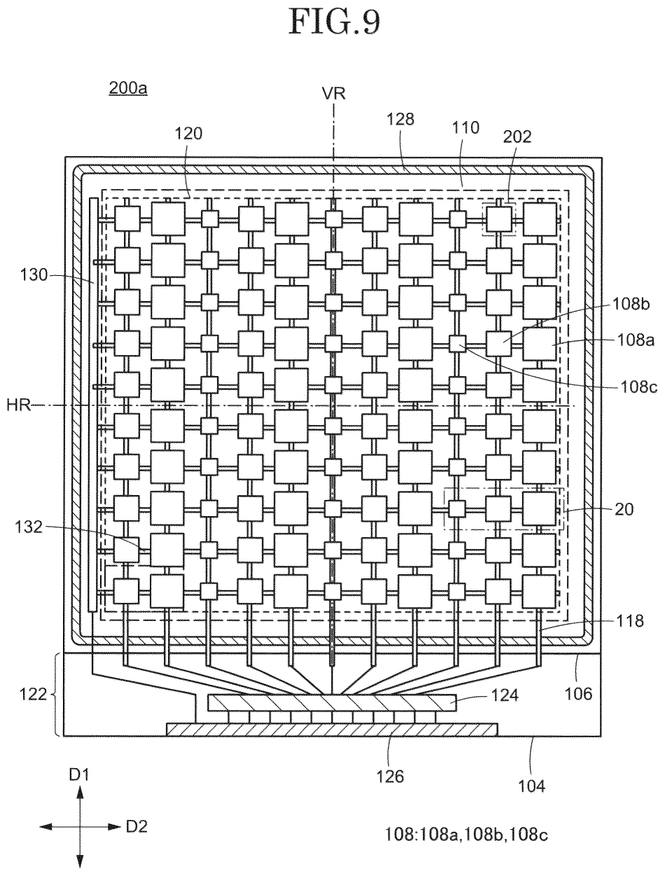

FIG. 9 is a plan view of a configuration of a radio-wave reflective device 200a in a modification of one embodiment of the present invention. The radio-wave reflective device 200a of this embodiment has a configuration in which the plurality of electrode groups 20 comprising the plurality of patch electrodes 108 aligned in the second direction (direction D2) are arranged along the first direction (direction D1). In an initial state, the radio-wave reflective device 200a of this embodiment is set so that a direction of travel of a reflected wave relative to an incident wave is inclined in the second direction (row direction) in advance. In other words, in a state before voltage control is applied to the radio-wave reflective device 200a, the reflected wave can be reflected toward a predetermined direction (in FIG. 9, along the second direction) in advance.

Furthermore, the radio-wave reflective device 200a can change the direction of travel toward the second direction with the reflection rotation axis VR as the axis or toward the first direction with the reflection axis HR as the rotation axis by voltage control. In the initial state, since the reflected wave is preset to head in the second direction, in the case where voltage control is performed, the direction of travel of the reflected wave can be further changed in the first or second direction from the preset direction as the reference. By performing such control, the radio-wave reflective device 200a can send radio waves to locations where radio waves cannot be sent by voltage control alone. Specifically, in the initial state, the direction of travel of the reflected wave by the radio-wave reflective device 200a is tilted toward a direction of the location, and the direction of the reflected wave is further changed by voltage control based on that direction, making it possible for the radio waves to reach the desired location.

The configuration of each of the above embodiments (including modifications) shown as an embodiment of the present invention can be combined as appropriate as long as they do not contradict each other. In addition, any addition, deletion, or design change of components, or any addition, omission, or change of conditions of processes, made by a person skilled in the art based on the configuration of each embodiment disclosed in this specification and the drawings, is also included in the scope of the invention as long as it has the gist of the invention.

Other effects different from those brought about by the embodiments disclosed herein, which are obvious from the description herein or which can be easily predicted by those skilled in the art, are naturally understood to be brought about by the present invention.

What is claimed is:

1. An intelligent reflecting surface comprising:
a plurality of patch electrodes;
a common electrode opposite the plurality of patch electrodes; and
a liquid crystal layer between the plurality of patch electrodes and the common electrode, wherein
the plurality of patch electrodes includes a first patch electrode, a second patch electrode adjacent to the first patch electrode, and a third patch electrode adjacent to the second patch electrode,
an area of the first patch electrode is larger than an area of the second patch electrode, and
the area of the second patch electrode is larger than an area of the third patch electrode.

2. The intelligent reflecting surface according to claim 1, wherein
the first patch electrode is adjacent to the second patch electrode in a first direction and adjacent to another first patch electrode in a second direction intersecting the first direction.

3. The intelligent reflecting surface according to claim 2, further comprising a first wiring extending in the first direction, wherein
the first patch electrode, the second patch electrode, and the third patch electrode are each connected to the first wiring.

4. The intelligent reflecting surface according to claim 3, wherein
the first wiring is arranged in a plurality of locations along the second direction.

5. The intelligent reflecting surface according to claim 4, wherein
a voltage applied to the first wiring and a voltage applied to another first wiring adjacent to the first wiring are different from each other.

6. The intelligent reflecting surface according to claim 2, further comprising a first wiring extending in the first direction, a second wiring extending in the second direction, and a switching element connected to the first wiring and the second wiring, wherein
the first patch electrode, the second patch electrode, and the third patch electrode are each electrically connected to the first wiring via the switching element.

7. The intelligent reflecting surface according to claim 6, wherein
a voltage applied to the first patch electrode, a voltage applied to the second patch electrode, and a voltage applied to the third patch electrode are different from each other.

8. The intelligent reflecting surface according to claim 6, wherein
the first wiring is arranged in a plurality of locations along the second direction.

9. The intelligent reflecting surface according to claim 8, wherein
a voltage applied to the first wiring and a voltage applied to another first wiring adjacent to the first wiring are different from each other.

10. The intelligent reflecting surface according to claim 1, wherein
a group of reflector unit cells including a first reflector unit cell containing the first patch electrode, a second reflector unit cell containing the second patch electrode, and a third reflector unit cell containing the third patch electrode are arranged in series.

11. An intelligent reflecting surface comprising:
a plurality of patch electrodes;
a common electrode opposite the plurality of patch electrodes; and
a liquid crystal layer between the plurality of patch electrodes and the common electrode, wherein
the plurality of patch electrodes includes a first patch electrode, a second patch electrode adjacent to the first patch electrode, and a third patch electrode adjacent to the second patch electrode, and
a first phase difference between a reflected wave by a first reflector unit cell containing the first patch electrode and a reflected wave by a second reflector unit cell containing the second patch electrode is the same as a second phase difference between the reflected wave by the second reflector unit cell and a reflected wave by a third reflector unit cell containing the third patch electrode.

12. The intelligent reflecting surface according to claim 11, wherein
the first patch electrode is adjacent to the second patch electrode in a first direction and adjacent to another first patch electrode in a second direction intersecting the first direction.

13. The intelligent reflecting surface according to claim 12, further comprising a first wiring extending in the first direction, wherein
the first patch electrode, the second patch electrode, and the third patch electrode are each connected to the first wiring.

14. The intelligent reflecting surface according to claim 13, wherein
the first wiring is arranged in a plurality of locations along the second direction.

15. The intelligent reflecting surface according to claim 14, wherein
a voltage applied to the first wiring and a voltage applied to another first wiring adjacent to the first wiring are different from each other.

16. The intelligent reflecting surface according to claim 12, further comprising a first wiring extending in the first direction, a second wiring extending in the second direction, and a switching element connected to the first wiring and the second wiring, wherein
the first patch electrode, the second patch electrode, and the third patch electrode are each electrically connected to the first wiring via the switching element.

17. The intelligent reflecting surface according to claim 16, wherein
a voltage applied to the first patch electrode, a voltage applied to the second patch electrode, and a voltage applied to the third patch electrode are different from each other.

18. The intelligent reflecting surface according to claim 16, wherein
the first wiring is arranged in a plurality of locations along the second direction.

19. The intelligent reflecting surface according to claim 18, wherein
a voltage applied to the first wiring and a voltage applied to another first wiring adjacent to the first wiring are different from each other.

20. The intelligent reflecting surface according to claim 11, wherein
a group of reflector unit cells including a first reflector unit cell containing the first patch electrode, a second reflector unit cell containing the second patch electrode, and a third reflector unit cell containing the third patch electrode are arranged in series.
